(19) United States
(12) Patent Application Publication
(10) Pub. No.: US 2024/0265440 A1
(43) Pub. Date: Aug. 8, 2024

(54) MULTI-LENDER, MULTI-BORROWER LOAN FACILITATION PLATFORM

(71) Applicant: Lendingkart Technologies Private Limited, Ahmedabad (IN)

(72) Inventors: Harshvardhan Lunia, GJ (IN); Abhishek Singh, Bengaluru (IN); Ashok Patidar, Akhepur (IN); Dhanesh Padmanabhan, Kolar (IN); Ram Deshpande, Bengaluru (IN); Ratul Paul, Mumbai (IN); Umesh Bhimani, Gandhinagar (IN)

(21) Appl. No.: 18/349,977

(22) Filed: Jul. 11, 2023

(30) Foreign Application Priority Data
Feb. 3, 2023 (IN) 202321007005

(51) Int. Cl. G06Q 40/03

(52) U.S. Cl. CPC G06Q 40/03

(57) ABSTRACT

A method and system for implementing a multi-lender, multi-borrower loan facilitation platform is provided. The system includes a memory element and processing circuitry. The processing circuitry receives a loan request from a borrower device of a borrower. Look-alike historical borrowers for the borrower are filtered based on historical data of past loans disbursed to historical borrowers and borrower profiles of the historical borrowers stored in the memory element. The processing circuitry determines an aggregate value for each lender of multiple lenders in the multi-lender, multi-borrower loan facilitation platform based on a rate component, an inventory utilization component, and a quality component of each lender. The processing circuitry ranks lenders for various interest rate bins that are selected based on the look-alike historical borrowers based on the aggregate value. The processing circuitry matches the loan request to a highest ranking lender for an interest rate bin selected by the borrower.

### CROSS REFERENCE TO RELATED APPLICATIONS

This application claims priority benefit of Indian Application No. US 202321007005, filed in the Indian Patent Office on Feb. 3, 2023. The above-referenced application is hereby incorporated herein by reference in its entirety.

### FIELD

Various embodiments of the disclosure relate generally to a loan facilitation platform. More specifically, various embodiments of the disclosure relate to a method and system for implementing a multi-lender, multi-borrower loan facilitation platform.

### BACKGROUND

Traditionally, a borrower approaches multiple lenders for getting a loan at a desired interest rate. The borrower makes a loan application for the loan at multiple lenders. Further, the borrower negotiates with each lender to get the loan disbursed at the desired interest rate and with a desired duration of loan repayment. Each lender processes the loan application to decide whether the loan can be disbursed. The borrower may get the loan from one of the multiple lenders. However, the traditional method of getting the loan is time consuming. Each lender processing the loan application and only one lender disbursing the loan results in wastage of resources.

In light of the foregoing, there exists a need for a technical and reliable solution that overcomes the abovementioned problems, and ensures efficient loan facilitation.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

Methods and systems for implementing multi-lender, multi-borrower loan facilitation platform are provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a system environment for implementing a multi-lender, multi-borrower loan facilitation platform, in accordance with an exemplary embodiment of the disclosure;

FIG. 2 is a block diagram that illustrates a processing circuitry of a system for implementing the multi-lender, multi-borrower loan facilitation platform of the system environment of FIG. 1, in accordance with an exemplary embodiment of the disclosure;

FIGS. 3A and 3B represent a flowchart that illustrates a method for implementing the multi-lender, multi-borrower loan facilitation platform, in accordance with an exemplary embodiment of the disclosure; and

FIG. 4 is a block diagram that illustrates a system architecture of a computer system for the implementation of the multi-lender, multi-borrower loan facilitation platform, in accordance with an exemplary embodiment of the disclosure.

### DETAILED DESCRIPTION

Certain embodiments of the disclosure may be found in disclosed systems and methods for implementing multi-lender, multi-borrower loan facilitation platform. Exemplary aspects of the disclosure provide methods and systems for implementing a multi-lender, multi-borrower loan facilitation platform. In an embodiment, a system for implementing a multi-lender, multi-borrower loan facilitation platform is disclosed. The system includes a network interface, a memory element, and processing circuitry. The network interface is communicatively coupled to a plurality of lender devices of a plurality of lenders and a plurality of borrower devices of a plurality of borrowers. The memory element is configured to store historical data of past loans disbursed to historical borrowers and borrower profiles of the historical borrowers. The processing circuitry is communicatively coupled to the memory element. The processing circuitry is configured to receive a loan request of a first borrower from a borrower device of the plurality of borrower devices. The processing circuitry is further configured to execute pattern matching on the borrower profiles stored in the memory element to filter look-alike historical borrowers for the first borrower. Further, the processing circuitry selects a plurality of interest rate bins for the first borrower based on interest rates at which past loans were disbursed to the look-alike historical borrowers. The processing circuitry is further configured to determine a rate component for each of the plurality of lenders for each of the plurality of interest rate bins. Further, the processing circuitry determines an inventory utilization component for each of the plurality of lenders based on a volume that a corresponding lender has disbursed in a time duration and a maximum committed volume by the corresponding lender for lending for the time duration. The processing circuitry is further configured to determine a quality component for each of the plurality of lenders based on a category of the first borrower, an amount committed for the category by the corresponding lender, and an amount already lent by the corresponding lender for other borrowers in the category. Further, the processing circuitry determines an aggregate value for each of the plurality of lenders for each of the plurality of interest rate bins based on the rate component at a corresponding interest rate bin, the inventory utilization component, and the quality component determined for the corresponding lender. The processing circuitry is further configured to rank the plurality of lenders for each of the plurality of interest rate bins based on the aggregate value determined for each of the plurality of lenders for a corresponding interest rate bin. The processing circuitry is further configured to receive a selection of one of the plurality of interest rate bins from the borrower device of the plurality of borrower devices. Further, the processing circuitry matches the loan request to a highest ranking lender among the plurality of lenders for the interest rate bin.

In another embodiment, a non-transitory computer-readable medium having stored thereon, computer-executable instructions which, when executed by a processor, cause the processor to execute operations is disclosed. The operations include receiving a loan request of a first borrower from a borrower device. The operations further include executing pattern matching on borrower profiles of historical borrowers to filter look-alike historical borrowers for the first borrower. The operations further include selecting a plurality of interest rate bins for the first borrower based on interest rates at which past loans were disbursed to the look-alike historical borrowers. The operations further include determining a rate component for each of a plurality of lenders for each of the plurality of interest rate bins. The operations further include determining an inventory utilization component for each of the plurality of lenders based on a volume that a corresponding lender has disbursed in a time duration and a maximum committed volume by the corresponding lender for lending for that time duration. The operations further include determining a quality component for each of the plurality of lenders based on a category of the first borrower, an amount committed for the category by the corresponding lender, and an amount already lent by the corresponding lender for other borrowers in the category. The operations further include determining an aggregate value for each of the plurality of lenders for each of the plurality of interest rate bins based on the rate component at a corresponding interest rate bin, the inventory utilization component, and the quality component determined for the corresponding lender. The operations further include ranking the plurality of lenders for each of the plurality of interest rate bins based on the aggregate value determined for each of the plurality of lenders for a corresponding interest rate bin. The operations further include receiving a selection of one of the plurality of interest rate bins from the borrower device. The operations further include matching the loan request to a highest ranking lender among the plurality of lenders for the selected interest rate bin.

In yet another embodiment, a method for implementing a multi-lender, multi-borrower loan facilitation platform is disclosed. The method includes receiving, by processing circuitry, from a borrower device, a loan request of a first borrower. The method further includes executing, by the processing circuitry, pattern matching on borrower profiles of historical borrowers to filter look-alike historical borrowers for the first borrower. Further, the method includes selecting, by the processing circuitry, a plurality of interest rate bins for the first borrower based on interest rates at which past loans were disbursed to the look-alike historical borrowers. The method further includes determining, by the processing circuitry, a rate component for each of a plurality of lenders for each of the plurality of interest rate bins. The method further includes determining, by the processing circuitry, an inventory utilization component for each of the plurality of lenders based on a volume that a corresponding lender has disbursed in a time duration and a maximum committed volume by the corresponding lender for lending for that time duration. The method further includes determining, by the processing circuitry, a quality component for each of the plurality of lenders based on a category of the first borrower, an amount committed for the category by the corresponding lender, and an amount already lent by the corresponding lender for other borrowers in the category. Further, the method includes determining, by the processing circuitry, an aggregate value for each of the plurality of lenders for each of the plurality of interest rate bins based on the rate component at a corresponding interest rate bin, the inventory utilization component, and the quality component determined for the corresponding lender. The method further includes ranking, by the processing circuitry, the plurality of lenders for each of the plurality of interest rate bins based on the aggregate value determined for each of the plurality of lenders for a corresponding interest rate bin. The method further includes receiving, from the borrower device, a selection of one of the plurality of interest rate bins. Further, the method includes matching, by the processing circuitry, the loan request to a highest ranking lender among the plurality of lenders for the selected interest rate bin.

In some embodiments, the aggregate value for each of the plurality of lenders for each of the plurality of interest rate bins is further determined based on a weighted sum of the rate component at a corresponding interest rate bin, the inventory utilization component, and the quality component determined for the corresponding lender.

In some embodiments, the memory element is further configured to store lending history information on the multi-lender, multi-borrower loan facilitation platform for each of the plurality of lenders.

In some embodiments, the processing circuitry is further configured to retrieve the lending history information of each of the plurality of lenders from the memory element. The processing circuitry is further configured to track, over a time period, one or more activities of the plurality of lenders related to accessing the multi-lender, multi-borrower loan facilitation platform on each of the plurality of lender devices. Further, the processing circuitry determines an elevation component for each of the plurality of lenders based on the lending history information of the corresponding lender and the tracked one or more activities of the corresponding lender.

In some embodiments, the aggregate value for each of the plurality of lenders for each of the plurality of interest rate bins is further determined based on the rate component at a corresponding interest rate bin, the inventory utilization component, the quality component, and the elevation component determined for the corresponding lender.

In some embodiments, the aggregate value for each of the plurality of lenders for each of the plurality of interest rate bins is further determined based on a weighted sum of the rate component at a corresponding interest rate bin, the inventory utilization component, the quality component, and the elevation component determined for the corresponding lender.

In some embodiments, the loan request includes one or more of a loan amount, a desirable interest rate of the first borrower, and a loan repayment duration.

In some embodiments, the processing circuitry determines the rate component for a lender of the plurality of lenders for an interest rate bin of the plurality of interest rate bins based on a hurdle rate, an interest rate of the interest rate bin, and a propensity of acceptance of the interest rate bin.

In some embodiments, the processing circuitry is further configured to compute the hurdle rate for the lender based on an impact cost associated with the lender.

In some embodiments, the processing circuitry is further configured to determine the propensity of acceptance of the interest rate bin by the first borrower based on the interest rates at which the past loans were disbursed to the look-alike historical borrowers.

In some embodiments, to execute pattern matching on the borrower profiles, the processing circuitry is further configured to process a profile of the first borrower to extract first values of a set of profile parameters. Further, the processing circuitry provides the first values for the set of profile parameters as an input to a trained neural network. The trained neural network generates a confidence score for each borrower profile stored in the memory element based on a degree of matching between the first values of the set of profile parameters and second values of the set of profile parameters associated with the corresponding borrower profile. Further, the processing circuitry receives the confidence score for each borrower profile stored in the memory element. The processing circuitry is further configured to filter those historical borrowers as the look-alike historical borrowers for which the confidence score of the borrower profile exceeds a threshold value.

In some embodiments, the set of profile parameters includes one or more of age, demographics, salary, gender, loan type of a loan application, data of active loans, credit score, escrow score, educational background, employment background, travel history, and social media history.

In some embodiments, the processing circuitry is further configured to render a graphical user interface on the borrower device. The graphical user interface is manipulated at the borrower device to submit a loan application.

In some embodiments, the memory element and the processing circuitry are implemented in a geographically distributed computing network.

In some embodiments, the plurality of lender devices and the plurality of borrower devices are geographically remote from the system.

Various embodiments of the present disclosure provide a system and method for implementing a multi-lender, multi-borrower loan facilitation platform. The system includes a memory element and processing circuitry. The processing circuitry receives a loan request from a borrower device of a borrower. The processing circuitry filters look-alike historical borrowers for the borrower based on historical data of past loans disbursed to historical borrowers and borrower profiles of the historical borrowers stored in the memory element. The processing circuitry determines an aggregate value for each lender of multiple lenders in the multi-lender, multi-borrower loan facilitation platform based on a rate component, an inventory utilization component, and a quality component of each lender. The processing circuitry ranks lenders for various interest rate bins that are selected based on the look-alike historical borrowers based on the aggregate value. The processing circuitry matches the loan request to a highest ranking lender for an interest rate bin selected by the borrower.

The disclosed system and method provide a multi-lender, multi-borrower loan facilitation platform that facilitates multiple borrowers to avail loans at desired interest rates and a desired duration of loan repayment without the need for the borrowers to apply for the loan at multiple lenders separately. Further, wastage of resources of the lenders is prevented as the lenders process the loan applications provided by the multi-lender, multi-borrower loan facilitation platform. As a result, efficient loan facilitation is ensured.

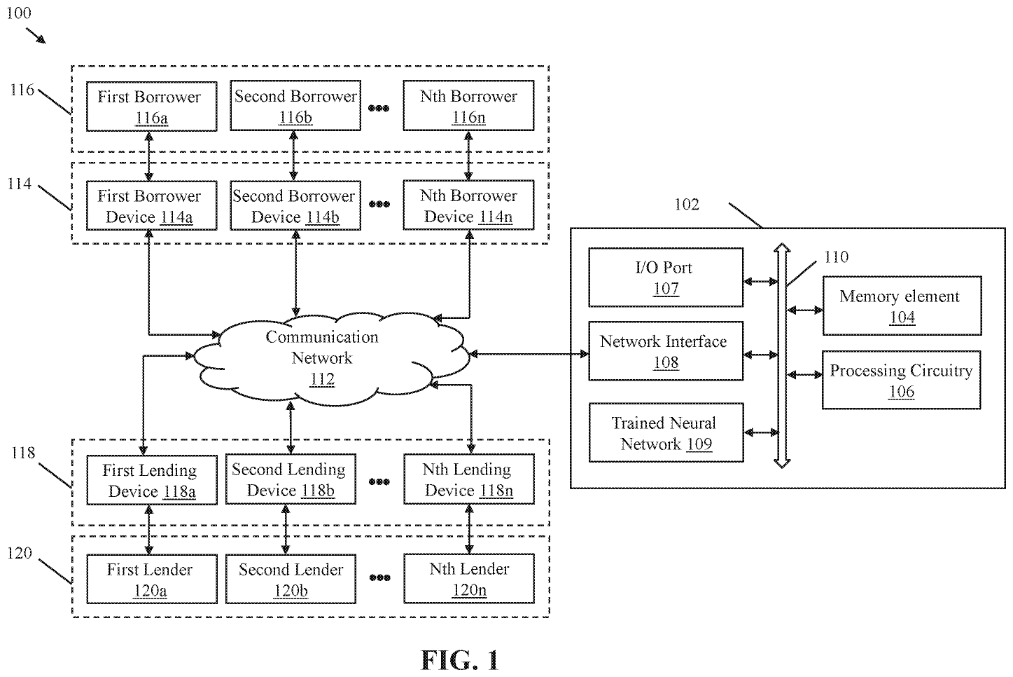

FIG. 1 is a block diagram that illustrates a system environment 100 for implementing a multi-lender, multi-borrower loan facilitation platform, in accordance with an embodiment of the present disclosure. The system environment 100 is shown to include a system 102 for implementing the multi-lender, multi-borrower loan facilitation platform. The system 102 may include a memory element 104, processing circuitry 106, an input/output (I/O) port 107, a network interface 108, and a trained neural network 109. The memory element 104, the processing circuitry 106, the I/O port 107, the network interface 108, and the trained neural network 109 are communicatively coupled to each other via a first communication bus 110. The system environment 100 is further shown to include a communication network 112 and a plurality of borrower devices 114 corresponding to a plurality of borrowers 116. The plurality of borrower devices 114 are coupled to the network interface 108 via the communication network 112. The system environment 100 is further shown to include a plurality of lender devices 118 corresponding to a plurality of lenders 120. The plurality of lender devices 118 are coupled to the network interface 108 via the communication network 112.

Examples of the communication network 112 may include, but are not limited to, a wireless fidelity (Wi-Fi) network, a light fidelity (Li-Fi) network, a wide area network (WAN), a metropolitan area network (MAN), the Internet, an infrared (IR) network, a radio frequency (RF) network, a near field communication (NFC) network, a Bluetooth network, a Zigbee network, and a combination thereof. Various entities (such as the plurality of borrower devices 114, the plurality of lender devices 118, and the network interface 108) in the system environment 100 may be coupled to the communication network 112 in accordance with various wired and wireless communication protocols, such as Transmission Control Protocol and Internet Protocol (TCP/IP), User Datagram Protocol (UDP), Long Term Evolution (LTE) communication protocols, an IEEE 802.11 standard protocol, an IEEE 802.15 standard protocol, an IEEE 802.15.4 standard protocol, or any combination thereof.

The system 102 may be configured to perform various functions to implement the multi-lender, multi-borrower loan facilitation platform.

The memory element 104 may include suitable logic, circuitry, and interfaces that may be configured to store, therein, historical data of past loans disbursed to historical borrowers and borrower profiles of the historical borrowers. The borrower profiles of the historical borrowers may include a set of profile parameters for each borrower of the historical borrowers. The set of profile parameters may include one or more of age, demographics, salary, gender, loan type of a loan application, data of active loans, credit score, escrow score, educational background, employment background, travel history, and social media history. The memory element 104 may be further configured to store lending history information on the multi-lender, multi-borrower loan facilitation platform for each of the plurality of lenders 120. The memory element 104 may be further configured to store a volume that each lender of the plurality of lenders has disbursed in a time duration and a maximum committed volume by each lender of the plurality of lenders 120 for lending during the time duration. The memory element may further be configured to store one or more instructions, which when executed by the processing circuitry 106 cause the processing circuitry 106 to perform various operations for implementing the multi-lender, multi-borrower loan facilitation platform.

Examples of the memory element 104 may include, but are not limited to, a random-access memory (RAM), a read-only memory (ROM), a removable storage drive, a hard disk drive (HDD), a flash memory, a solid-state memory, or the like. It will be apparent to a person skilled in the art that the scope of the disclosure is not limited to realizing the memory element 104 in the system 102, as described herein. In other embodiments, the memory element may be realized in the form of a database or a cloud storage working in conjunction with the processing circuitry 106, without deviating from the scope of the disclosure.

The processing circuitry 106 may include suitable logic, circuitry, interfaces, and/or code, executable by the circuitry, that may be configured to perform various functions for implementing the multi-lender, multi-borrower loan facilitation platform. The processing circuitry 106 may be configured to render a graphical user interface on a first borrower device 114a of the plurality of borrower devices 114. The graphical user interface is manipulated by a first borrower 116a of the plurality of borrowers 116 at the first borrower device 114a to submit a loan application or a loan request. The processing circuitry 106 may be configured to receive the loan request of the first borrower 116a from the first borrower device 114a of the plurality of borrower devices 114.

The processing circuitry 106 may be further configured to execute pattern matching on the borrower profiles stored in the memory element 104 to filter look-alike historical borrowers for the first borrower 116a. The processing circuitry 106 processes a profile of the first borrower 116a to extract first values of the set of profile parameters. Further, the processing circuitry 106 provides the first values for the set of profile parameters as an input to a trained neural network 109. The trained neural network 109 generates a confidence score for each borrower profile of the historical borrowers stored in the memory element 104 based on a degree of matching between the first values of the set of profile parameters and second values of the set of profile parameters associated with the corresponding borrower profile. Further, the processing circuitry 106 receives the confidence score for each borrower profile stored in the memory element 104. The processing circuitry 106 filters those historical borrowers as the look-alike historical borrowers for which the confidence score of the borrower profile exceeds a threshold value.

Further, the processing circuitry 106 may be configured to select a plurality of interest rate bins for the first borrower 116a based on interest rates at which past loans were disbursed to the look-alike historical borrowers. The processing circuitry 106 is further configured to determine a rate component for each of the plurality of lenders 120 for each of the plurality of interest rate bins. The processing circuitry 106 determines the rate component for a lender of the plurality of lenders 120 for an interest rate bin of the plurality of interest rate bins based on a hurdle rate, an interest rate of the interest rate bin, and a propensity of acceptance of the interest rate bin. The processing circuitry 106 computes the hurdle rate for each lender of the plurality of lenders 120 based on an impact cost associated with the corresponding lender. For example, the impact cost is based on one or more of an interest rate offered by the corresponding lender, taxes applicable, or the like. Further, the processing circuitry 106 determines the propensity of acceptance of each of the plurality of interest rate bins by the first borrower 116a based on the interest rates at which the past loans were disbursed to the look-alike historical borrowers.

The processing circuitry 106 is further configured to determine an inventory utilization component for each of the plurality of lenders 120 based on a volume that a corresponding lender has disbursed in a time duration and a maximum committed volume by the corresponding lender for lending for the time duration. The processing circuitry 106 is further configured to determine a quality component for each of the plurality of lenders 120 based on a category of the first borrower, an amount committed for the category by the corresponding lender, and an amount already lent by the corresponding lender for other borrowers in the category. In an example, the first borrower 116a may belong to one of a high risk category, a medium risk category, or a low risk category. In an embodiment, the processing circuitry 106 categorizes the first borrower 116a based on certain features of the first borrower 116a, such as one or more of nature of business of the first borrower 116a, mortgage provided by the first borrower 116a, nature of repayment of historical loans borrowed by the first borrower 116a, or the like. In another embodiment, the processing circuitry 106 categorizes the first borrower 116a based on the profile of the first borrower 116a.

The processing circuitry 106 is further configured to determine an aggregate value for each of the plurality of lenders 120 for each of the plurality of interest rate bins based on the rate component at a corresponding interest rate bin, the inventory utilization component, and the quality component determined for the corresponding lender. Further, the processing circuitry 106 ranks the plurality of lenders 120 for each of the plurality of interest rate bins based on the aggregate value determined for each of the plurality of lenders 120 for a corresponding interest rate bin. Further, the processing circuitry 106 receives a selection of one of the plurality of interest rate bins from the first borrower device 114a of the plurality of borrower devices 114. Further, the processing circuitry matches the loan request to a highest ranking lender among the plurality of lenders 120 for the selected interest rate bin.

In an embodiment, the processing circuitry 106 may be configured to retrieve the lending history information of each of the plurality of lenders 120 from the memory element 104. Further, the processing circuitry 106 tracks one or more activities of the plurality of lenders 120, related to accessing the multi-lender, multi-borrower loan facilitation platform over a time period, on each of the plurality of lender devices 118. Further, the processing circuitry 106 determines an elevation component for each of the plurality of lenders 120 based on the lending history information of the corresponding lender and the tracked one or more activities of the corresponding lender. In an embodiment, the aggregate value of each lender may further be based on the elevation component of the corresponding lender.

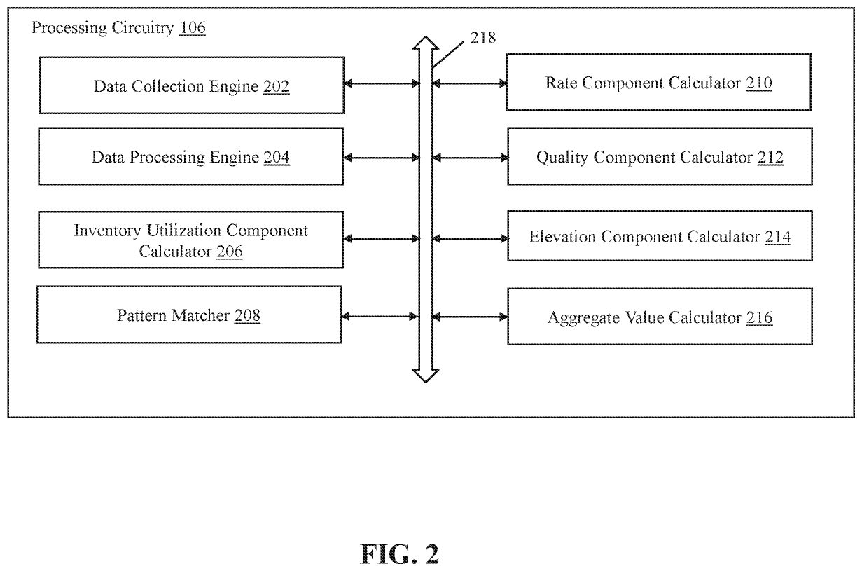

Examples of the processing circuitry 106 may include, but are not limited to, an application-specific integrated circuit (ASIC) processor, a reduced instruction set computing (RISC) processor, a complex instruction set computing (CISC) processor, and a field-programmable gate array (FPGA). It will be apparent to a person of ordinary skill in the art that the circuitry 106 may be compatible with multiple operating systems. The processing circuitry 106 is further described in detail in conjunction with FIG. 2.

In an embodiment, the memory element 104 and the processing circuitry 106 are implemented in a geographically distributed computing network.

The I/O port 107 includes suitable logic, circuitry, and/or interfaces that are operable to execute one or more instructions stored in the memory element 104 to perform one or more operations. The I/O port 107 may include various input and output devices that are configured to operate under the control of the processing circuitry 106 by way of the first communication bus 110. For example, via the I/O port 107, an administrator associated with the system 102 provides one or more inputs to perform one or more operations. Examples of the input devices may include a universal serial bus (USB) port, an Ethernet port, a real or virtual keyboard, a mouse, a joystick, a touch screen, a stylus, a microphone, and the like. Examples of the output devices may include a display screen, a speaker, headphones, a universal serial bus (USB) port, an Ethernet port, and the like.

The network interface 108 may include suitable logic, circuitry, interfaces, and/or code, executable by the circuitry, for facilitating communication using one or more communication protocols. The network interface 108 may be communicatively coupled to the plurality of borrower devices 114 and the plurality of lender devices 118 via the communication network 112. Examples of the network interface 108 may include, but are not limited to, an antenna, a radio frequency transceiver, a wireless transceiver, a Bluetooth transceiver, an ethernet-based transceiver, a universal serial bus (USB) transceiver, an NFC-based transceiver, or any other device configured to transmit and receive data.

The trained neural network 109 may be configured to receive the first values for the set of profile parameters as an input from the processing circuitry 106. Further, the trained neural network 109 generates the confidence score for each borrower profile of the historical borrowers stored in the memory element 104 based on the degree of matching between the first values of the set of profile parameters and the second values of the set of profile parameters associated with the corresponding borrower profile. The trained neural network 109 provides the confidence score generated for each borrower profile of the historical borrowers to the processing circuitry 106. In an embodiment, the processing circuitry may be configured to train a neural network to generate the trained neural network 109 based on training data set and testing dataset stored in the memory element 104. The training dataset and the testing dataset may include the profile parameters of the historical borrowers. Examples of the trained neural network 109 may include, but are not limited to, a convolutional neural network (CNN), a recurrent neural network (RNN), a radial basis functional neural network, a deep neural network model, a long short-term memory (LSTM) model, or the like.

The plurality of borrower devices 114 may include the first borrower device 114a, a second borrower device 114b, and so on till an Nth borrower device 114n. Each borrower device of the plurality of borrower devices 114 may be utilized by a corresponding borrower of the plurality of borrowers 116 to raise the loan request, select one of the plurality of interest rate bins, receive information regarding a lender of the plurality of lenders 120 matched to the loan request, or the like. The loan request may include one or more of a loan amount, a desirable interest rate of the first borrower 116a, and a loan repayment duration. Each borrower device of the plurality of borrower devices 114 may be utilized by the corresponding borrower of the plurality of borrowers 116 to avail services of the multi-lender, multi-borrower loan facilitation platform utilizing a service application installed on the borrower device. The plurality of borrowers 116 may include the first borrower 116a, a second borrower 116b, and so on till an Nth borrower 116n. Each borrower device of the plurality of borrower devices 114 is associated with a corresponding borrower of the plurality of borrowers 116. In a non-limiting example, the first borrower device 114a is associated with the first borrower 116a and the second borrower device 114b is associated with the second borrower 116b. Examples of the borrower device may include, but are not limited to, a smartphone, a tablet, a phablet, a personal digital assistant, a laptop, a computer, or the like.

The plurality of lender devices 118 may include a first lender device 118a, a second lender device 118b, and so on till an Nth lender device 118n. Each lender device of the plurality of lender devices 118 may be utilized by the corresponding lender of the plurality of lenders 120 for accessing the multi-lender, multi-borrower loan facilitation platform. The plurality of lenders 120 may include a first lender 120a, a second lender 120b, and so on till an Nth lender 120n. Each lender of the plurality of lenders 120n may be one of an individual, a financial institution, a public sector unit, or the like. Each lender device of the plurality of lender devices 118 is associated with a corresponding lender of the plurality of lenders 120. In a non-limiting example, the first lender device 118a is associated with the first lender 120a and the second lender device 118b is associated with the second lender 120b. Each lender device of the plurality of lender devices 118 may be utilized by the corresponding lender of the plurality of lenders 120 to avail services of the multi-lender, multi-borrower loan facilitation platform utilizing a service application installed on the lender device. In a non-limiting example, the first lender 120a may provide an amount committed to be lent for a specified time duration via the first lender device 118a, interest rate for disbursing the loan, loan repayment duration, or the like. Examples of the lender device may include, but are not limited to a smartphone, a tablet, a phablet, a personal digital assistant, a laptop, a computer, or the like.

The plurality of lender devices 118 and the plurality of borrower devices 114 are geographically remote from the system 102.

FIG. 2 is a block diagram that illustrates the processing circuitry 106 of the system 102, in accordance with an embodiment of the present disclosure. The processing circuitry 106 may include a data collection engine 202, a data processing engine 204, an inventory utilization component calculator 206, a pattern matcher 208, a rate component calculator 210, a quality component calculator 212, an elevation component calculator 214, and an aggregate value calculator 216. The data collection engine 202, the data processing engine 204, the inventory utilization component calculator 206, the pattern matcher 208, the rate component calculator 210, the quality component calculator 212, the elevation component calculator 214, and the aggregate value calculator 216 are communicatively coupled to each other via a second communication bus 218.

In operation, the data processing engine 204 is configured to render the graphical user interface on the first borrower device 114a. Further, the graphical user interface is manipulated at the first borrower device 114a by the first borrower 116a to submit the loan application (also referred to as the loan request). The data collection engine 202 receives the loan request of the first borrower 116a from the first borrower device 114a. The loan request may include one or more of the loan amount, the desirable interest rate of the first borrower 116a, and the loan repayment duration. The data collection engine 202 may further receive a profile of the first borrower 116a from the first borrower device 114a. Further, the data collection engine 202 provides the received loan request and the profile of the first borrower 116a to the pattern matcher 208. The profile of the first borrower may be further stored in the memory element 104. In an embodiment, the profile of the first borrower may be stored in the memory element 104 before receiving the loan request. The pattern matcher 208 executes the pattern matching on the borrower profiles of the historical borrowers stored in the memory element 104 to filter look-alike historical borrowers for the first borrower 116a. To perform the pattern matching, the pattern matcher 208 processes the profile of the first borrower to extract first values of the set of profile parameters. The set of profile parameters includes one or more of age, demographics, salary, gender, loan type of a loan application, data of active loans, credit score, escrow score, educational background, employment background, travel history, and social media history.

Further, the pattern matcher 208 provides the first values for the set of profile parameters as the input to the trained neural network 109. The trained neural network 109 generates a confidence score for each borrower profile of the historical borrowers that is stored in the memory element 104 based on the degree of matching between the first values of the set of profile parameters and the second values of the set of profile parameters associated with the corresponding borrower profile of the historical borrowers. The pattern matcher 208 receives the confidence score for each borrower profile of the historical borrowers stored in the memory element 104. Further, the pattern matcher 208 filters those historical borrowers as the look-alike historical borrowers for which the confidence score of the borrower profile exceeds a threshold value. The pattern matcher 208 provides the borrower profiles of the look-alike historical borrowers to the data processing engine 204. Further, the borrower profiles of the look-alike historical borrowers may be stored in the memory element 104.

The data processing engine 204 selects the plurality of interest rate bins for the first borrower 116a based on the interest rates at which the past loans were disbursed to the look-alike historical borrowers. The plurality of interest rate bins may include a first interest rate bin, a second interest rate bin, a third interest rate bin, and so on till an nth interest rate bin.

Further, the data collection engine 202 may extract the volume that each lender of the plurality of lenders has disbursed in a time duration and the maximum committed volume by each lender of the plurality of lenders for lending during the time duration from the memory element 104. The time duration may be in days, months, or years. In a non-limiting example, the time duration is 15 days. The data collection engine 202 may further provide the extracted data to the inventory utilization component calculator 206. The inventory utilization component calculator 206 determines the inventory utilization component for each lender of the plurality of lenders 120 based on the volume that a corresponding lender has disbursed in a time duration and the maximum committed volume by the corresponding lender for lending in the time duration. The inventory utilization component calculator 206 determines the inventory utilization component for the first lender 120a of the plurality of lenders 120 by utilizing the following equation (1).

$${I}_{1} = 1 - \frac{{V}_{1}}{M C {V}_{1}} \qquad ( 1 )$$

where,
I₁ is the inventory utilization component for the first lender 120a;
V₁ is a volume disbursed by the first lender 120a in a time duration; and
MCV₁ is a maximum committed volume by the first lender 120a for lending in the time duration.

The inventory utilization components for the second lender 120b till the Nth lender 120n are calculated in a similar manner as the calculation of the inventory utilization component for the first lender 120a by the inventory utilization component calculator 206.

In an embodiment, when the loan request is to be matched to a lender of the plurality of lenders 120 based on the inventory utilization components, the lender with a higher value of the inventory utilization component is matched to the loan request. A lender of the plurality of lenders who has disbursed a lowest amount or has not disbursed any amount in comparison to the maximum committed volume may have the highest value of the inventory utilization component. The inventory utilization component calculator 206 provides the inventory utilization components of the plurality of the lenders 120n to the aggregate value calculator 216.

The rate component calculator 210 is configured to calculate the rate component for each lender of the plurality of lenders 120. The rate component for a lender of the plurality of lenders 120 for an interest rate bin of the plurality of interest rate bins is calculated based on a hurdle rate, an interest rate of the interest rate bin, and a propensity of acceptance of the interest rate bin. The rate component calculator 210 calculates the hurdle rate for each lender of the plurality of lenders 120 based on an impact cost associated with the corresponding lender. In an example, the impact cost is based on an interest rate offered by the corresponding lender, taxes, or the like. The memory element 104 may be further configured to store data associated with the impact cost for each lender of the plurality of lenders 120. The data collection engine 202 may extract the data associated with the impact cost for each lender of the plurality of lenders 120 and provide the extracted data to the rate component calculator 210 for the calculation of the hurdle rate for each lender of the plurality of lenders 120. In an embodiment, the rate component calculator 210 may be further configured to store the hurdle rate for each lender of the plurality of lenders 120 in the memory element 104 in correlation to each lender of the plurality of lenders 120.

The data processing engine 204 determines the propensity of acceptance of each interest rate bin of the plurality of interest rate bins for each lender of the plurality of lenders 120 based on the interest rates at which the past loans were disbursed to the look-alike historical borrowers. The data processing engine 204 provides the determined propensity of acceptance of each interest rate bin of the plurality of interest rate bins for each lender of the plurality of lenders 120 to the rate component calculator 210. The determined propensity of acceptance of each interest rate bin of the plurality of interest rate bins for each lender of the plurality of lenders may be stored in the memory element 104. The rate component calculator 210 calculates an intermediate component for each lender of the plurality of lenders for each interest rate bin of the plurality of interest rate bins. An intermediate component for the first lender 120a of the plurality of lenders 120 for the first interest rate bin of the plurality of interest rate bins is calculated by the rate component calculator 210 by utilizing the following equation (2).

$${IC}_{11} = {P}_{1} ( {B}_{1} - {H}_{1} ) \qquad ( 2 )$$

where,
IC₁₁ is the intermediate component for the first lender 120a for the first interest rate bin;
P₁ is the propensity of acceptance of the first interest rate bin by the first borrower 116a;
B₁ is the interest rate of the first interest rate bin; and
H₁ is the hurdle rate for the first lender 120a.

The intermediate components are similarly calculated for the first lender 120a for the remaining interest rate bins of the plurality of interest rate bins. Further, the intermediate components for the second lender 120b till the Nth lender 120n of the plurality of lenders 120 for each interest rate bin of the plurality of interest rate bins are calculated in a similar manner as the calculation of the intermediate components for the first lender 120a for each interest rate bin of the plurality of interest rate bins by the rate component calculator 210.

Further, the rate component calculator 210, calculates a rate component for the first lender 120a for the first interest rate bin of the plurality of interest rate bins by utilizing the following equation (3).

$${R}_{11} = \frac{[ {IC}_{11} - Maximum ( {IC}_{11} , {IC}_{12} , {IC}_{13} , … , {IC}_{1 n} ]}{[ Maximum ( {IC}_{11} , {IC}_{12} , {IC}_{13} , … , {IC}_{1 n} ) - Minimum ( {IC}_{11} , {IC}_{12} , {IC}_{13} , … , {IC}_{1 n} ) ]} \qquad ( 3 )$$

where,
R₁₁ is the rate component for the first lender 120a for the first interest rate bin; and
IC₁₁, IC₁₂, IC₁₃, . . . , IC₁ₙ are the intermediate components for the first lender 120a for each interest rate bin of the plurality of interest rate bins.

The rate components are similarly calculated for the first lender 120a for the remaining interest rate bins of the plurality of interest rate bins. The rate components for the second lender 120b till the Nth lender 120n of the plurality of lenders 120 for each interest rate bin of the plurality of interest rate bins are calculated in a similar manner as the calculation of the rate components for the first lender 120a by the rate component calculator 210. The rate component for each lender of the plurality of lenders 120 indicates a profitability index generated by each lender of the plurality of lenders 120 for the multi-lender, multi-borrower loan facilitation platform. The rate component calculator 210 provides the rate components of the plurality of the lenders 120 for the plurality of interest rate bins to the aggregate value calculator 216.

The quality component calculator 212 calculates the quality component for each lender of the plurality of lenders 120. The first borrower 116a may be categorized into one of a plurality of categories based on the profile of the first borrower 116a. In an example, the plurality of categories includes a high risk category, a medium risk category, and a low risk category. The data processing engine 204 determines the category of the first borrower 116a and provides the determined category to the quality component calculator 212. The memory element 104 may be configured to store a combination of different categories of borrowers for each lender of the plurality of lenders 120. In an example, the first lender 120a has a combination that specifies that 50% of the maximum committed volume by the first lender 120a in the time duration is to be allocated to lenders categorized in the high risk category. Further, 20% of the maximum committed volume by the first lender 120a in the time duration is to be allocated to the lenders categorized in the medium risk category. Further, 30% of the maximum committed volume by the first lender 120a in the time duration is to be allocated to the lenders categorized in the low risk category. In an embodiment, the memory element 104 may be configured to store a plurality of combinations of the plurality of categories in correlation to a plurality of hurdle rates. The quality component calculator 212 may extract the combination of the plurality of categories for each lender of the plurality of lenders 120 based on the hurdle rate of the corresponding lender from the memory element 104. The quality component calculator 212 calculates a quality component for the first lender 120a by utilizing the following equation (4).

$${Q}_{1} = 1 - \frac{{VC}_{1}}{M C V {C}_{1}} \qquad ( 4 )$$

where,
Q₁ is the quality component of the first lender 120a;
VC₁ is a volume disbursed by the first lender 120a in the category of the first borrower 116a in the time duration; and
MCVC₁ is a maximum committed volume for the category of the first borrower 116a by the first lender 120a for lending in the time duration.

The quality component for the second lender 120b till the Nth lender 120n are calculated in a similar manner as the calculation of the quality component of the first lender 120a by the quality component calculator 212.

In an embodiment, when the loan request is to be matched to a lender of the plurality of lenders 120 based on the quality components, the lender with a higher value of the quality component is matched to the loan request. A lender of the plurality of lenders 120 who has disbursed a lowest amount or has not disbursed any amount in the category of the first borrower in comparison to the maximum committed volume for the category may have the highest value of the quality component. The quality component calculator 212 provides the quality components of the plurality of the lenders 120n to the aggregate value calculator 216.

The elevation component calculator 214 determines the elevation component for each lender of the plurality of lenders 120. The elevation component retrieves the lending history information of each of the plurality of lenders 120 from the memory element 104. Further, the elevation component tracks one or more activities of the plurality of lenders related to accessing the multi-lender, multi-borrower loan facilitation platform on each of the plurality of lender devices 118a-118n over a time period. In an example, one or more activities may include lending pattern of the plurality of lenders, a time duration between the approval of the loan request and disbursal of the loan to the borrower, or the like. Further, the elevation component calculator 214 determines the elevation component for each of the plurality of lenders 120 based on the lending history information of the corresponding lender and the tracked one or more activities of the corresponding lender. The value of the elevation component for each lender of the plurality of lenders 120 may lie in a range of 0 to 1. In an embodiment, an administrator associated with the multi-lender, multi-borrower loan facilitation platform may set the value of the elevation component for one or more lenders of the plurality of lenders 120 via the I/O port 107. The elevation component calculator 214 provides the elevation components of the plurality of the lenders 120n to the aggregate value calculator 216.

In an embodiment, the aggregate value calculator 216 calculates the aggregate value for each lender of the plurality of lenders 120 based on the inventory utilization component, the rate component at a corresponding interest rate bin of the plurality of interest rate bins, and the quality component determined for the corresponding lender. The aggregate value is a summation of the inventory utilization component, the rate component at a corresponding interest rate bin of the plurality of interest rate bins, and the quality component determined for the corresponding lender. In another embodiment, the aggregate value calculator 216 calculates the aggregate value for each lender of the plurality of lenders 120 based on the inventory utilization component, the rate component at a corresponding interest rate bin of the plurality of interest rate bins, the quality component determined for the corresponding lender, and the elevation component determined for the corresponding lender. The aggregate value is a summation of the inventory utilization component, the rate component at a corresponding interest rate bin of the plurality of interest rate bins, the quality component determined for the corresponding lender, and the elevation component for the corresponding lender.

In yet another embodiment, the aggregate value for each of the plurality of lenders 120 for each of the plurality of interest rate bins is may be determined based on a weighted sum of the rate component at a corresponding interest rate bin, the inventory utilization component, and the quality component determined for the corresponding lender. In yet another embodiment, the aggregate value for each of the plurality of lenders 120 for each of the plurality of interest rate bins is further determined based on a weighted sum of the rate component at a corresponding interest rate bin, the inventory utilization component, the quality component, and the elevation component determined for the corresponding lender. The aggregate value calculator 216 provides the aggregate value for each of the plurality of lenders 120 for each of the plurality of interest rate bins to the data processing engine 204.

The data processing engine 204 may be configured to rank the plurality of lenders 120 for each of the plurality of interest rate bins based on the aggregate value determined for each of the plurality of lenders 120 for a corresponding interest rate bin. Further, the data processing engine 204 retrieves the propensity of acceptance of each interest rate bin of the plurality of interest rate bins for each lender of the plurality of lenders 120 from the memory element 104. Further, the data processing engine 204 identifies an interest rate bin with a highest value of propensity of acceptance. Further, the data processing engine 204 transmits an interest rate of an interest rate bin that has an interest rate that is greater by a first value to the interest rate of the identified interest rate bin to the first borrower device 114a associated with the first borrower 116a. The data processing engine 204 transmits the interest rate via the network interface 108 and the communication network 112. If the first borrower 116a accepts the interest rate transmitted by the data processing engine 204, the data processing engine 204 further identifies the interest rate bin corresponding to the transmitted interest rate as the interest rate bin selected by the first borrower 116a.

In a non-limiting example, when the data processing engine 204 identifies that a fifth interest rate bin with an interest rate of 20% has the highest propensity of acceptance, the data processing engine 204 transmits 30% that is the interest rate of a seventh interest rate bin to the borrower device 114a of the first borrower 116a. If the first borrower 116a accepts the interest rate transmitted by the data processing engine 204, the data processing engine 204 further identifies the seventh interest rate bin as the interest rate bin selected by the first borrower 116a. The first borrower 116a may be provided with an option to accept the interest rate or negotiate the interest rate. If the first borrower 116a chooses to negotiate the transmitted interest rate, the data processing engine 204 further transmits 25% which is the interest rate of a sixth interest rate bin of the plurality of interest rate bins to the first borrower 116a. If the first borrower 116a accepts the interest rate transmitted by the data processing engine 204, the data processing engine 204 identifies the sixth interest rate bin as the interest rate bin selected by the first borrower 116a. If the first borrower 116a chooses to negotiate the transmitted interest rate, the data processing engine 204 further transmits an interest rate of the fifth interest rate bin to the first borrower 116a. In an embodiment, the first borrower 116a is provided with an option to either accept or decline the interest rate of the fifth interest rate bin. In another embodiment, the first borrower 116a is further provided with the option to accept or negotiate the transmitted interest rate. The data processing engine 204 identifies the interest rate bin selected by the first borrower 116a based on the interest rate accepted by the first borrower 116a.

The data processing engine 204 matches the loan request of the first borrower 116a to a highest ranking lender in the interest rate bin selected by the first borrower 116a. A lender with the highest aggregate value for the interest rate bin selected by the first borrower 116a is the highest ranking lender. Further, the data processing engine 204 may transmit a confirmation message to the first borrower device 114a of the first borrower 116a indicating that the loan request is approved. The confirmation message may further indicate one or more of the highest ranking lender in the interest rate bin selected by the first borrower 116a, the loan amount, and the loan repayment duration. The remaining borrowers of the plurality of borrowers 116 may raise loan requests and the processing circuitry 106 matches the loan requests to corresponding lenders of the plurality of lenders as the matching loan request of the first borrower 116a to the highest ranking lender in the interest rate bin selected by the first borrower 116a.

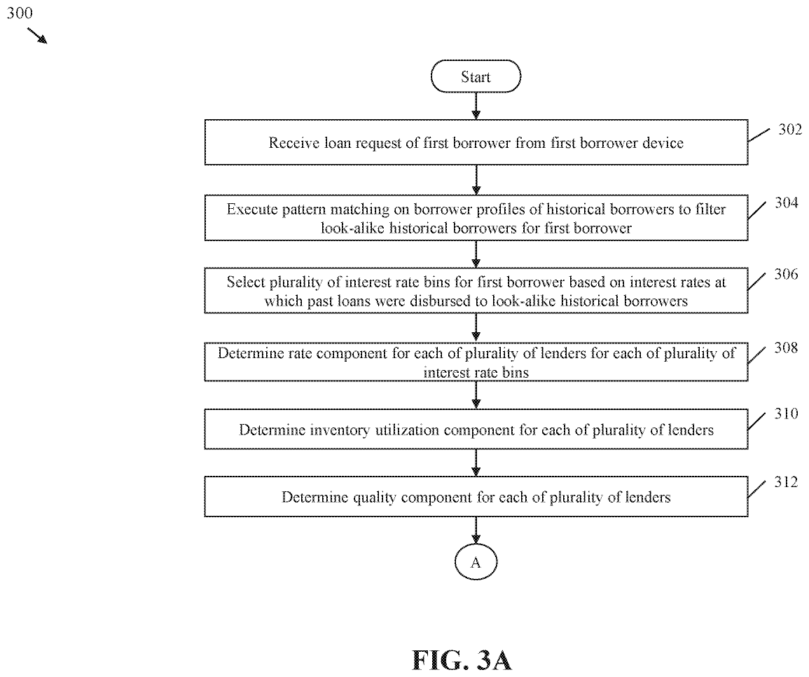

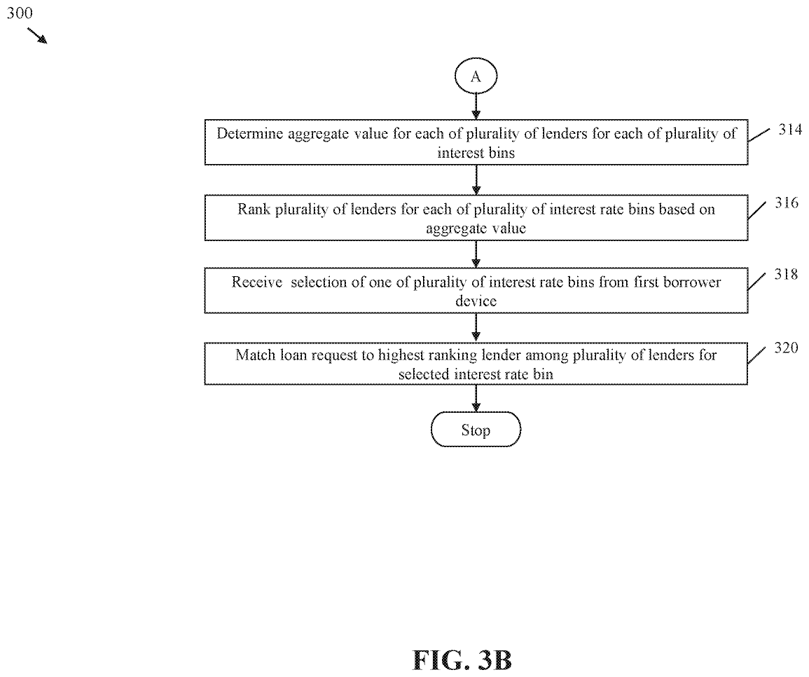

FIGS. 3A and 3B represent a flowchart 300 that illustrates a method for implementing the multi-lender, multi-borrower loan facilitation platform, in accordance with an embodiment of the present disclosure.

At step 302, the processing circuitry 106 receives the loan request of the first borrower 116a from the first borrower device 114a. The processing circuitry 106 receives the loan request via the network interface 108. The loan request may include one or more of the loan amount, the desirable interest rate of the first borrower, and the loan repayment duration. In other words, the data collection engine 202 receives the loan request.

At step 304, the processing circuitry 106 executes pattern matching on the borrower profiles of the historical borrowers to filter look-alike historical borrowers for the first borrower 116a. The borrower profiles of the historical borrowers are stored in the memory element 104. To perform the pattern matching, the pattern matcher 208 processes the profile of the first borrower to extract the first values of the set of profile parameters. The set of profile parameters includes one or more of age, demographics, salary, gender, loan type of a loan application, data of active loans, credit score, escrow score, educational background, employment background, travel history, and social media history.

Further, the pattern matcher 208 provides the first values for the set of profile parameters as the input to the trained neural network 109. The trained neural network 109 generates the confidence score for each borrower profile of the historical borrowers that is stored in the memory element 104 based on the degree of matching between the first values of the set of profile parameters and the second values of the set of profile parameters associated with the corresponding borrower profile of the historical borrowers. The pattern matcher 208 receives the confidence score for each borrower profile of the historical borrowers stored in the memory element 104. Further, the pattern matcher 208 filters those historical borrowers as the look-alike historical borrowers for which the confidence score of the borrower profile exceeds a threshold value.

At step 306, the processing circuitry 106 selects the plurality of interest rate bins for the first borrower 116a based on the interest rates at which past loans were disbursed to the look-alike historical borrowers. In other words, the data processing engine 204 selects the plurality of interest rate bins for the first borrower 116a based on the interest rates at which the past loans were disbursed to the look-alike historical borrowers.

At step 308, the processing circuitry 106 determines the rate component for each of the plurality of lenders 120 for each of the plurality of interest rate bins. The rate component for each of the plurality of lenders 120 for each of the plurality of interest rate bins is determined based on the hurdle rate, the interest rate of the interest rate bin, and the propensity of acceptance of the interest rate bin. In other words, the rate component calculator 210 calculates the rate component for each of the plurality of lenders 120 for each of the plurality of interest rate bins.

At step 310, the processing circuitry 106 determines the inventory utilization component for each of plurality of lenders 120 based on the volume that a corresponding lender has disbursed in a time duration and the maximum committed volume by the corresponding lender for lending in the time duration. A lender of the plurality of lenders who has disbursed a lowest amount or has not disbursed any amount may have the highest value of the inventory utilization component. In other words, the inventory utilization component calculator 206 calculates the inventory utilization component for each of plurality of lenders 120 based on the volume that a corresponding lender has disbursed in a time duration and the maximum committed volume by the corresponding lender for lending in the time duration.

At step 312, the processing circuitry 106 determines the quality component for each of plurality of lenders 120 based on the category of the first borrower 116a, an amount committed for the category by the corresponding lender, and an amount already lent by the corresponding lender for other borrowers in the category of the first borrower 116a. In other words, the quality component calculator 212 calculates the quality component for each of plurality of lenders 120 based on the category of the first borrower 116a, an amount committed for the category by the corresponding lender, and an amount already lent by the corresponding lender for other borrowers in the category of the first borrower 116a.

At step 314, the processing circuitry 106 determines the aggregate value for each of the plurality of lenders 120 for each of the plurality of interest bins based on the rate component at a corresponding interest rate bin, the inventory utilization component, and the quality component determined for the corresponding lender. In other words, the aggregate value calculator 216 calculates the aggregate value for each of the plurality of lenders 120 for each of the plurality of interest bins based on the rate component at a corresponding interest rate bin, the inventory utilization component, and the quality component determined for the corresponding lender. The aggregate value is a sum of the rate component at a corresponding interest rate bin, the inventory utilization component, and the quality component determined for the corresponding lender. In another embodiment, the processing circuitry 106 determines the aggregate value for each of the plurality of lenders 120 for each of the plurality of interest bins based on the rate component at a corresponding interest rate bin, the inventory utilization component, the quality component determined for the corresponding lender, and the elevation component for the corresponding lender.

At step 316, the processing circuitry 106 ranks the plurality of lenders 120 for each of the plurality of interest rate bins based on the aggregate value determined for each of the plurality of lenders 120 for a corresponding interest rate bin. In other words, the data processing engine 204 ranks the plurality of lenders 120 for each of the plurality of interest rate bins based on the aggregate value determined for each of the plurality of lenders 120 for a corresponding interest rate bin.

At step 318, the processing circuitry 106 receives the selection of one of the plurality of interest rate bins from the first borrower device 114a of the plurality of borrower devices 114. The selection of one of the plurality of interest rate bins is performed by the first borrower 116a via the first borrower device 114a. In other words, the data collection engine 202 receives the selection of one of the plurality of interest rate bins from the first borrower device 114a of the plurality of borrower devices 114. The data collection engine 202 provides the selection of one of the plurality of interest rate bins to the data processing engine 204.

At step 320, the processing circuitry 106 matches the loan request to a highest ranking lender among the plurality of lenders for the interest rate bin selected by the first borrower 116a. A lender with the highest aggregate value for the interest rate bin selected by the first borrower 116a is the highest ranking lender. In other words, the data processing engine 204 matches the loan request to the highest ranking lender among the plurality of lenders for the interest rate bin selected by the first borrower 116a.

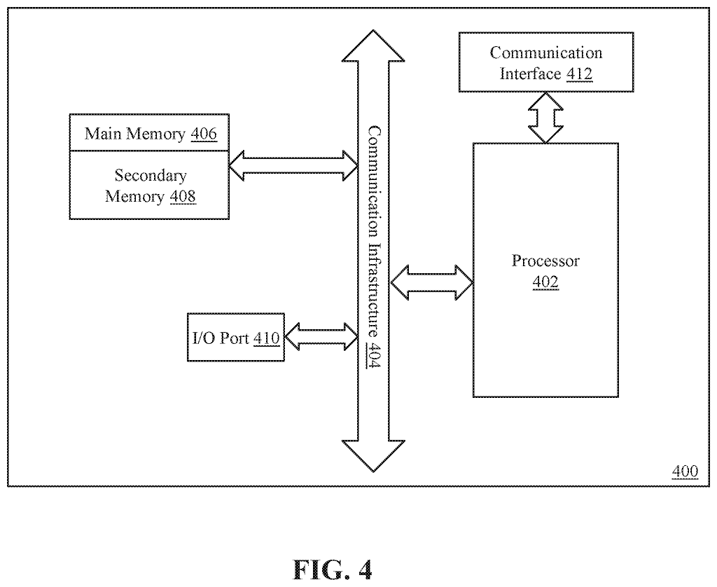

FIG. 4 is a block diagram that illustrates a system architecture of a computer system 400 for the implementation of the multi-lender, multi-borrower loan facilitation platform, in accordance with an exemplary embodiment of the disclosure. An embodiment of the disclosure, or portions thereof, may be implemented as computer-readable code on the computer system 400. In one example, the system 102 of FIG. 1 may be implemented in the computer system 400 using hardware, software, firmware, a non-transitory computer-readable medium having instructions stored thereon, or a combination thereof, and may be implemented in one or more computer systems or other processing systems. Hardware, software, or any combination thereof may embody modules and components used to implement the method of FIGS. 3A and 3B.

The computer system 400 may include a processor 402 that may be a special-purpose or a general-purpose processing device. The processor 402 may be a single processor or multiple processors. The processor 402 may have one or more processor “cores.” Further, the processor 402 may be coupled to a communication infrastructure 404, such as a bus, a bridge, a message queue, the communication network 112, a multi-core message-passing scheme, or the like. The computer system 400 may further include a main memory 406 and a secondary memory 408. Examples of the main memory 406 may include RAM, ROM, and the like. The secondary memory 408 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer-readable recording medium.

The computer system 400 may further include an input/output (I/O) port 410 and a communication interface 412. The I/O port 410 may include various input and output devices that are configured to communicate with the processor 402. Examples of the input devices may include a keyboard, a mouse, a joystick, a touchscreen, a microphone, and the like. Examples of the output devices may include a display screen, a speaker, headphones, and the like. The communication interface 412 may be configured to allow data to be transferred between the computer system 400 and various devices that are communicatively coupled to the computer system 400. Examples of the communication interface 412 may include a modem, a network interface, i.e., an Ethernet card, a communication port, and the like. Data transferred via the communication interface 412 may be signals, such as electronic, electromagnetic, optical, or other signals as will be apparent to a person skilled in the art. The signals may travel via a communications channel, such as the communication network 112, which may be configured to transmit the signals to the various devices that are communicatively coupled to the computer system 400. Examples of the communication channel may include wired, wireless, and/or optical media such as cable, fiber optics, a phone line, a cellular phone link, a radio frequency link, and the like. The main memory 406 and the secondary memory 408 may refer to non-transitory computer-readable mediums that may provide data that enables the computer system 400 to implement the methods illustrated in FIGS. 3A and 3B.

The disclosed embodiments encompass numerous advantages. The system 102 implements the multi-lender, multi-borrower loan facilitation platform that facilitates the borrowers to get loans at desired interest rate and with desired duration of loan repayment without requiring the borrowers to apply for loans at multiple lenders and wait to get quotations from the lenders. Thus, the borrowers get loans disbursed in a shorter time duration in comparison to traditional systems. Further, the conversion rate of loan applications to loans is higher for the lenders as the system 102 matches the loan request to a lender based on a propensity of acceptance of an interest rate by the corresponding lender. Further, the system 102 matches the loan request to a lender by considering various factors that benefit both the borrowers and lenders.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, systems and methods for implementing the multi-lender, multi-borrower loan facilitation platform. While various exemplary embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A system for implementing a multi-lender, multi-borrower loan facilitation platform, the system comprising:
a network interface communicatively coupled to a plurality of lender devices of a plurality of lenders and a plurality of borrower devices of a plurality of borrowers;
a memory element configured to store historical data of past loans disbursed to historical borrowers and borrower profiles of the historical borrowers; and
processing circuitry communicatively coupled to the memory element, wherein the processing circuitry is configured to:
receive, from a borrower device of the plurality of borrower devices, a loan request of a first borrower;
execute pattern matching on the borrower profiles stored in the memory element to filter look-alike historical borrowers for the first borrower;
select a plurality of interest rate bins for the first borrower based on interest rates at which past loans were disbursed to the look-alike historical borrowers;
determine a rate component for each of the plurality of lenders for each of the plurality of interest rate bins;
determine an inventory utilization component for each of the plurality of lenders based on a volume that a corresponding lender has disbursed in a time duration and a maximum committed volume by the corresponding lender for lending for the time duration;
determine a quality component for each of the plurality of lenders based on a category of the first borrower, an amount committed for the category by the corresponding lender, and an amount already lent by the corresponding lender for other borrowers in the category;
determine an aggregate value for each of the plurality of lenders for each of the plurality of interest rate bins based on the rate component at a corresponding interest rate bin, the inventory utilization component, and the quality component determined for the corresponding lender;
rank the plurality of lenders for each of the plurality of interest rate bins based on the aggregate value determined for each of the plurality of lenders for a corresponding interest rate bin;
receive, from the borrower device of the plurality of borrower devices, a selection of one of the plurality of interest rate bins; and
match the loan request to a highest ranking lender among the plurality of lenders for the interest rate bin.

2. The system as claimed in claim 1, wherein the aggregate value for each of the plurality of lenders for each of the plurality of interest rate bins is further determined based on a weighted sum of the rate component at a corresponding interest rate bin, the inventory utilization component, and the quality component determined for the corresponding lender.

3. The system as claimed in claim 1, wherein the memory element is further configured to store lending history information on the multi-lender, multi-borrower loan facilitation platform for each of the plurality of lenders.

4. The system as claimed in claim 3, wherein the processing circuitry is further configured to:
retrieve the lending history information of each of the plurality of lenders from the memory element;
track, over a time period, one or more activities of the plurality of lenders related to accessing the multi-lender, multi-borrower loan facilitation platform on each of the plurality of lender devices; and
determine an elevation component for each of the plurality of lenders based on the lending history information of the corresponding lender and the tracked one or more activities of the corresponding lender.

5. The system as claimed in claim 4, wherein the aggregate value for each of the plurality of lenders for each of the plurality of interest rate bins is further determined based on the rate component at a corresponding interest rate bin, the inventory utilization component, the quality component, and the elevation component determined for the corresponding lender.

6. The system as claimed in claim 4, wherein the aggregate value for each of the plurality of lenders for each of the plurality of interest rate bins is further determined based on a weighted sum of the rate component at a corresponding interest rate bin, the inventory utilization component, the quality component, and the elevation component determined for the corresponding lender.

7. The system as claimed in claim 1, wherein the loan request includes one or more of a loan amount, a desirable interest rate of the first borrower, and a loan repayment duration.

8. The system as claimed in claim 1, wherein the processing circuitry determines the rate component for a lender of the plurality of lenders for an interest rate bin of the plurality of interest rate bins based on a hurdle rate, an interest rate of the interest rate bin, and a propensity of acceptance of the interest rate bin.

9. The system as claimed in claim 8, wherein the processing circuitry is further configured to compute the hurdle rate for the lender based on an impact cost associated with the lender.

10. The system as claimed in claim 8, wherein the processing circuitry is further configured to determine the propensity of acceptance of the interest rate bin by the first borrower based on the interest rates at which the past loans were disbursed to the look-alike historical borrowers.

11. The system as claimed in claim 1, wherein to execute pattern matching on the borrower profiles, the processing circuitry is further configured to:
process a profile of the first borrower to extract first values of a set of profile parameters;
provide the first values for the set of profile parameters as an input to a trained neural network, wherein the trained neural network generates a confidence score for each borrower profile stored in the memory element based on a degree of matching between the first values of the set of profile parameters and second values of the set of profile parameters associated with the corresponding borrower profile;
receive the confidence score for each borrower profile stored in the memory element; and
filter those historical borrowers as the look-alike historical borrowers for which the confidence score of the borrower profile exceeds a threshold value.

12. The system as claimed in claim 11, wherein the set of profile parameters includes one or more of age, demographics, salary, gender, loan type of a loan application, data of active loans, credit score, escrow score, educational background, employment background, travel history, and social media history.

13. The system as claimed in claim 1, wherein the processing circuitry is further configured to render a graphical user interface on the borrower device, wherein the graphical user interface is manipulated at the borrower device to submit a loan application.

14. The system as claimed in claim 1, wherein the memory element and the processing circuitry are implemented in a geographically distributed computing network.

15. The system as claimed in claim 1, wherein the plurality of lender devices and the plurality of borrower devices are geographically remote from the system.

16. A non-transitory computer-readable medium having stored thereon, computer-executable instructions which, when executed by a processor, cause the processor to execute operations, the operations comprising:
receiving, from a borrower device, a loan request of a first borrower;
executing pattern matching on borrower profiles of historical borrowers to filter look-alike historical borrowers for the first borrower;
selecting a plurality of interest rate bins for the first borrower based on interest rates at which past loans were disbursed to the look-alike historical borrowers;
determining a rate component for each of a plurality of lenders for each of the plurality of interest rate bins;
determining an inventory utilization component for each of the plurality of lenders based on a volume that a corresponding lender has disbursed in a time duration and a maximum committed volume by the corresponding lender for lending for that time duration;
determining a quality component for each of the plurality of lenders based on a category of the first borrower, an amount committed for the category by the corresponding lender, and an amount already lent by the corresponding lender for other borrowers in the category;
determining an aggregate value for each of the plurality of lenders for each of the plurality of interest rate bins based on the rate component at a corresponding interest rate bin, the inventory utilization component, and the quality component determined for the corresponding lender;
ranking the plurality of lenders for each of the plurality of interest rate bins based on the aggregate value determined for each of the plurality of lenders for a corresponding interest rate bin;
receiving, from the borrower device, a selection of one of the plurality of interest rate bins; and
matching the loan request to a highest ranking lender among the plurality of lenders for the selected interest rate bin.

17. A method for implementing a multi-lender, multi-borrower loan facilitation platform, the method comprising:
receiving, by processing circuitry, from a borrower device, a loan request of a first borrower;
executing, by the processing circuitry, pattern matching on borrower profiles of historical borrowers to filter look-alike historical borrowers for the first borrower;
selecting, by the processing circuitry, a plurality of interest rate bins for the first borrower based on interest rates at which past loans were disbursed to the look-alike historical borrowers;
determining, by the processing circuitry, a rate component for each of a plurality of lenders for each of the plurality of interest rate bins;
determining, by the processing circuitry, an inventory utilization component for each of the plurality of lenders based on a volume that a corresponding lender has disbursed in a time duration and a maximum committed volume by the corresponding lender for lending for that time duration;
determining, by the processing circuitry, a quality component for each of the plurality of lenders based on a category of the first borrower, an amount committed for the category by the corresponding lender, and an amount already lent by the corresponding lender for other borrowers in the category;
determining, by the processing circuitry, an aggregate value for each of the plurality of lenders for each of the plurality of interest rate bins based on the rate component at a corresponding interest rate bin, the inventory utilization component, and the quality component determined for the corresponding lender;
ranking, by the processing circuitry, the plurality of lenders for each of the plurality of interest rate bins based on the aggregate value determined for each of the plurality of lenders for a corresponding interest rate bin;
receiving, from the borrower device, a selection of one of the plurality of interest rate bins; and
matching, by the processing circuitry, the loan request to a highest ranking lender among the plurality of lenders for the selected interest rate bin.
